(19) United States
(12) Patent Application Publication
(10) Pub. No.: US 2015/0342823 A1
(43) Pub. Date: Dec. 3, 2015

(54) Hair and Scalp Revitalization

(71) Applicant: Linda Barnett, Tumwater, WA (US)

(72) Inventor: Linda Barnett, Tumwater, WA (US)

(21) Appl. No.: 14/295,277

(22) Filed: Jun. 3, 2014

(51) Int. Cl. A61H 7/00

(52) U.S. Cl. CPC A61H 7/003

(57) ABSTRACT

The instant application discloses, among other things, techniques to provide for Hair and Scalp Revitalization. In one embodiment, a person may shampoo a head of hair using lukewarm water, scrubbing the entire scalp vigorously yet gently. The person may then blot the hair with a towel until the hair reaches a wet, but not dripping, state. While the hair is wet, the person may use a brush or comb to gently detangle the strands. The person may then use a brush, which may have a cushion base and flexible teeth, to perform vigorous strokes over the entire scalp, applying pressure on areas such as the top, temple, crown, and nape of the head and neck, for instance. The pressure on the scalp may stimulate blood circulation, eliminate toxins, and maximize nutrients to improve the health of the hair and scalp and, in most cases, regenerate hair growth.

### FIELD

This disclosure relates generally to Hair and Scalp Revitalization.

### BACKGROUND

Individuals of all ages may experience problems with the hair and scalp. Issues may include excessive shedding, thinning, balding, dandruff, limp, lank, flat, lifeless, or dull hair, tenderness of the scalp, or scalp sores, for instance. Hair and scalp problems may stem from factors such as malnutrition, hormonal imbalance, genetics, stress, and diseases such as cancer, surgery or chemotherapy treatments, or a deficiency of blood flow to the scalp. Other factors may affect hair and scalp, including diet or systemic imbalances. A common misconception in the hair and medical industries is that people should brush the strands of the hair but not the scalp. Another common misconception is that topical products are an effective remedy for hair loss and other hair health issues.

### SUMMARY

The instant application discloses, among other things, techniques to provide for Hair and Scalp Revitalization. In one embodiment, a person may first shampoo a head of hair using lukewarm water, scrubbing the entire scalp vigorously yet gently. The person may then blot the hair with a towel until the hair reaches a wet, but not dripping, state. While the hair is wet, the person may use a brush or comb to gently detangle the strands. The person may then use a brush, which may have a cushion base and flexible teeth, to perform vigorous short strokes over the entire scalp, applying pressure on areas such as the top, corners, crown, and nape of the head and neck, for instance. The pressure on the scalp may stimulate blood circulation, reduce toxins, and increase nutrients to improve the health of the hair and scalp, and may regenerate hair growth.

In another embodiment, a person may brush hair while it is dry, brushing front to top, corners toward back, sides up, crown toward the back, and back toward the top, with vigorous, short strokes.

### BRIEF DESCRIPTION OF THE DRAWINGS

FIG. 1 is a flow diagram illustrating Hair and Scalp Revitalization, according to one embodiment.

FIG. 2 is a flow diagram illustrating Hair and Scalp Revitalization, according to another embodiment.

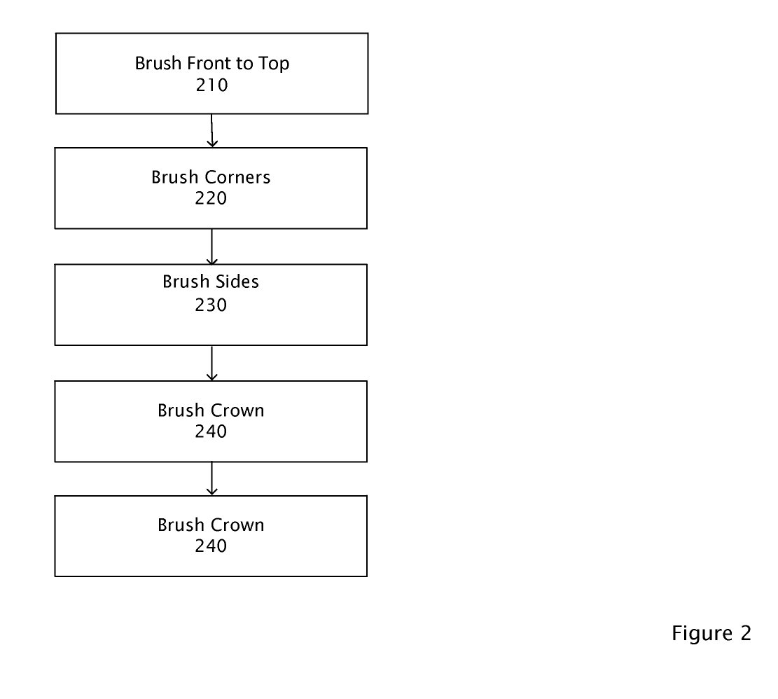

FIG. 3 illustrates one step of a proper brushing technique in Hair and Scalp Revitalization, according to one embodiment.

FIG. 4 illustrates another step of a proper brushing technique in Hair and Scalp Revitalization, according to one embodiment.

FIG. 5 illustrates a third step of a proper brushing technique in Hair and Scalp Revitalization, according to one embodiment.

FIG. 6 illustrates another step of a proper brushing technique in Hair and Scalp Revitalization, according to one embodiment.

FIG. 7 illustrates another step of a proper brushing technique in Hair and Scalp Revitalization, according to one embodiment.

### DETAILED DESCRIPTION

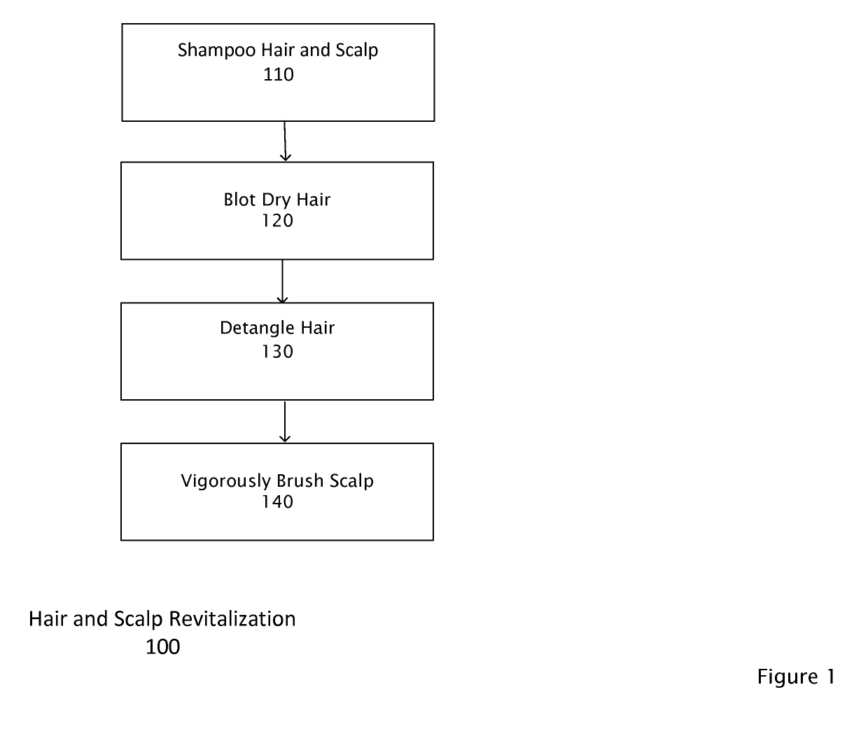

FIG. 1 is a flow diagram illustrating Hair and Scalp Revitalization 100, according to one embodiment. At Shampoo Hair and Scalp 110, a person, such as a cosmetologist, medical professional, or other person, may wash the hair and scalp of the subject. The subject may have any type of hair or scalp condition. The person may use any combination of substances to wash the hair, such as water, a gentle shampoo, or a conditioner suitable for the particular hair type. The person may use lukewarm, as opposed to hot, water to prevent heat damage to the hair and scalp. Using the pads of their fingers, the person may vigorously, yet gently, scrub the entire scalp area of hair.

At Blot Dry Hair 120, the person may use a towel to gently pat dry the hair to a wet, but not dripping, state. The person may refrain from rubbing or ruffling the hair with the towel, as this may diminish the health and integrity of the strands. The person may also avoid towel wrapping the hair, as this may inhibit the ability to style the hair.

At Detangle Hair 130, the person may use any device such as a comb or brush, for instance, to gently separate the hair strands. The person may begin by detangling the bottom sections of the hair and work his or her way up, toward the scalp.

At Vigorously Brush Scalp 140, the person may vigorously yet gently brush the subject's entire scalp area by performing repeated, sustained, short strokes that put pressure on, for example, the top, temple, crown, side, and nape portions of the head and neck. The person may use a brush with a cushioned base and flexible teeth separated at the base, for example, to vigorously brush the scalp. The person may apply as much pressure as is comfortable for the subject, and may spend additional time stimulating problem areas, such as sections with dull or thinning hair, for instance, than other areas of the scalp. Vigorously Brush Scalp 140 may stimulate blood flow, bringing the hair growing mechanism faster circulation, remove accumulated toxins, and maximize nutrients needed for a healthy scalp and hair. Vigorously Brush Scalp 140 may be performed for any duration, for example, approximately two minutes, and may be repeated twice daily, such as once in the morning and once in the evening. Brushing may be done with the hair wet or dry, but at least once a day it should be brushed dry.

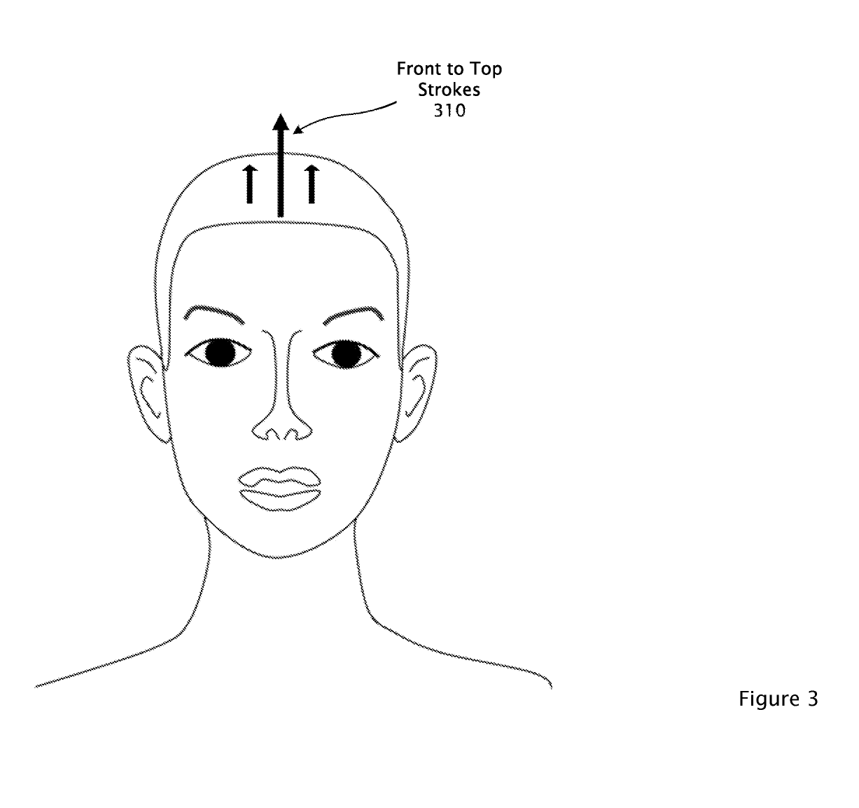

FIG. 3 illustrates one step of a proper brushing technique in Hair and Scalp Revitalization 100, according to one embodiment. During Front to Top Strokes 310, the person may begin with the top of the head, moving the brush with comfortable pressure applied, from the front hairline straight back along the top of the head, giving several short strokes to this area.

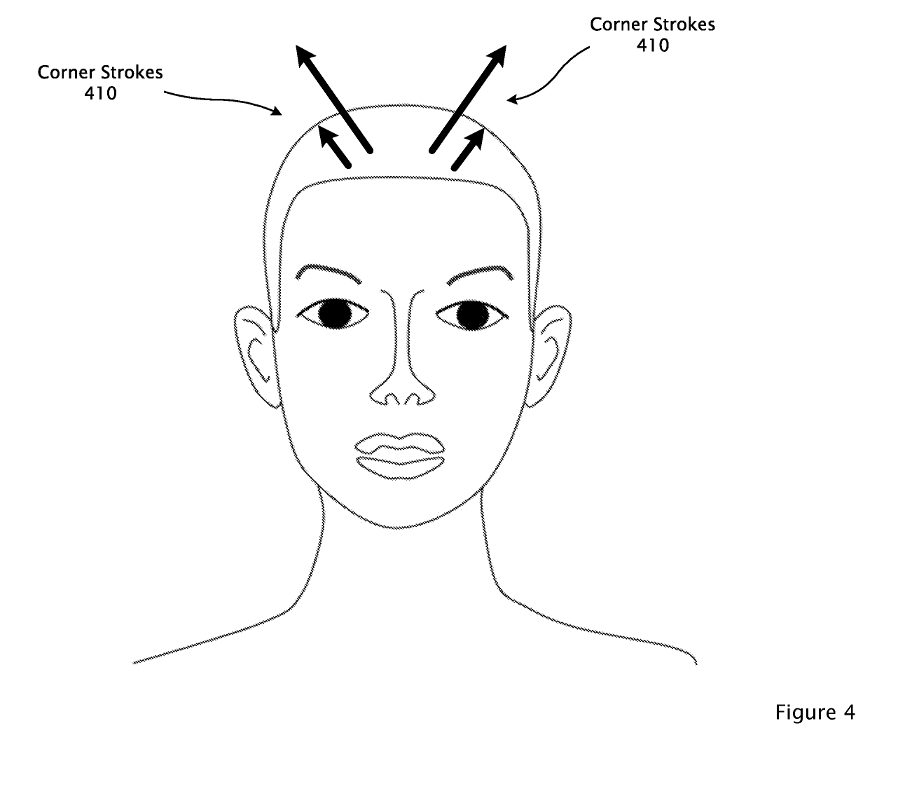

FIG. 4 illustrates another step of a proper brushing technique in Hair and Scalp Revitalization 100, according to one embodiment. During Corner Strokes 410, the person may then brush the temple, or corner, areas of the scalp in repeated, sustained, and vigorous motions, each time bringing the brush from the front to the back of the temple area.

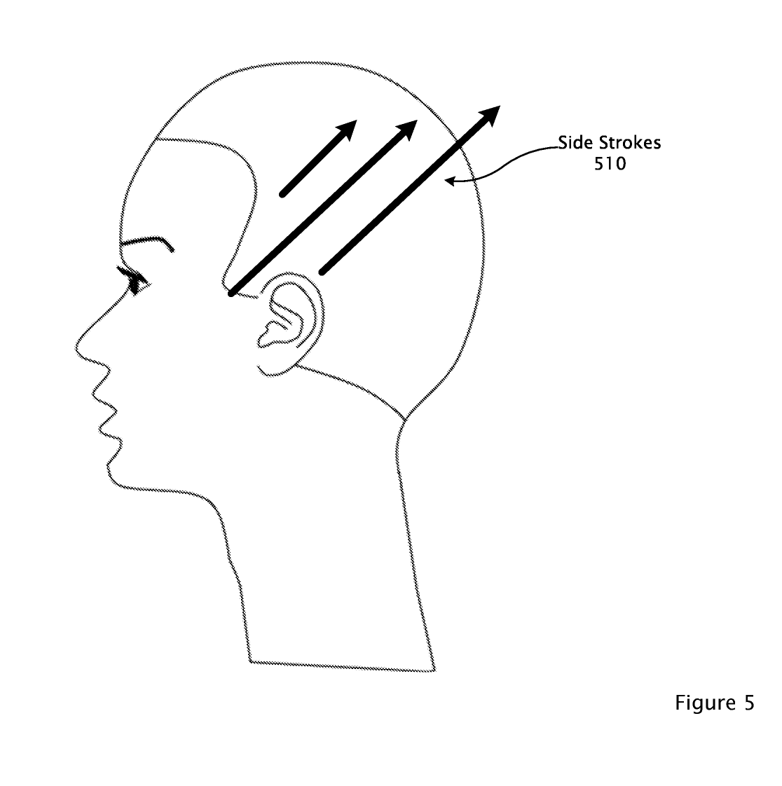

FIG. 5 illustrates another step of a proper brushing technique in Hair and Scalp Revitalization 100, according to one embodiment. During Side Strokes 510, the person may bring the brush to the sides of the head, in the area above and in front of the ears. The person may use the brush to perform repeated, sustained, and vigorous strokes in an upward and back angle, lifting the hair up under the root.

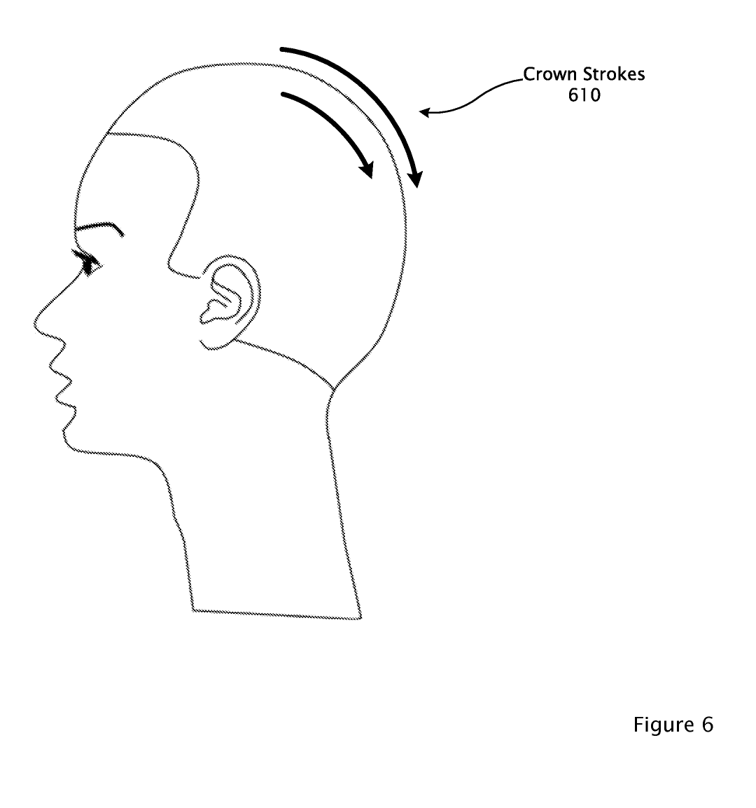

FIG. 6 illustrates another step of a proper brushing technique in Hair and Scalp Revitalization 100, according to one embodiment. During Crown Strokes 610, the person may bring the brush to the top of the head and perform repeated sustained and vigorous strokes over the curve of the crown and to the bottom of the crown region.

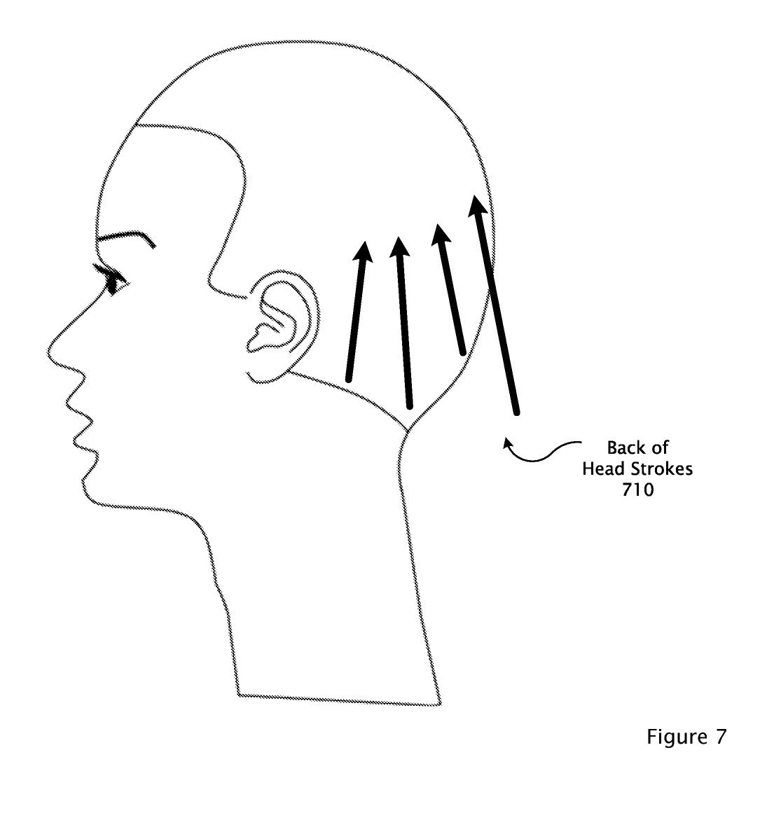

FIG. 7 illustrates another step of a proper brushing technique in Hair and Scalp Revitalization 100, according to one embodiment. At Back of Head Strokes 710, the person may bring the brush to the back of the head and perform repeated, sustained, and vigorous strokes from the nape of the neck, upward to the lower crown, and outward toward the edges of the scalp, behind the ear. The person may also brush the entire back of the head, including around the hairline.

1. A hair and scalp revitalization method, comprising the steps of:
shampooing the hair and the scalp;
blot drying the hair using a towel;
brushing the scalp using short, vigorous strokes; comprising:
brushing from a front of the scalp toward the ton;
brushing from a front of a first temple to a back of the first temple;
brushing from a front of a second temple to a back of the second temple;
brushing upward from in front of a first ear toward a to of the scalp;
brushing upward from in front of a second ear toward a to of the scalp;
brushing downward from the to of the scalp over a crown portion of the scalp toward a back of the scalp; and
brushing upward from a nape of the neck to the to of the scalp.

2. The method of claim 1, wherein shampooing the hair and the scalp comprises using a combination of water, shampoo, and conditioner.

3-4. (canceled)

5. The method of claim 1, wherein brushing the scalp comprises stroking the entire scalp area in short, vigorous motions.

6. The method of claim 1, wherein brushing the scalp comprises repeatedly stroking the top, temple, side, crown, and nape areas of the head and neck.

7-9. (canceled)
